(19) United States
(12) Patent Application Publication
(10) Pub. No.: US 2011/0042858 A1
(43) Pub. Date: Feb. 24, 2011

(54) METHOD OF MAKING MOLDS WITH PRODUCTION READY SURFACES

(76) Inventor: Samuel D. Vinch, JR., Clinton Township, MI (US)

Correspondence Address: YOUNG BASILE, 3001 WEST BIG BEAVER ROAD, SUITE 624, TROY, MI, 48084, US

(21) Appl. No.: 12/859,608

(22) Filed: Aug. 19, 2010

Related U.S. Application Data
(60) Provisional application No. 61/235,091, filed on Aug. 19, 2009.

(51) Int. Cl. B29C 35/04; B29C 33/38

(52) U.S. Cl. 264/401; 264/226

(57) ABSTRACT

Disclosed herein are methods of making a mold having a production-ready surface as defined herein. One disclosed method comprises creating an expanded geometric computer model of a mold. A physical model of the mold is produced based on the expanded geometric computer model using a material that disintegrates at sufficient temperature. A ceramic cast from the physical model is created, and then a molten metal is poured into the ceramic cast, thereby disintegrating the physical model. The molten metal is cooled and the ceramic cast is removed from the cooled metal to reveal the mold having the production-ready surface.

### CROSS REFERENCE TO RELATED APPLICATION

This application claims priority to U.S. Provisional Patent Application Ser. No. 61/235,091, filed Aug. 19, 2009, the entire contents of which is incorporated herein by reference.

### TECHNICAL FIELD

The present invention relates in general to an improved process for manufacturing various types of molds, such as plastic injection molds, blow molds, compression molds, vacuum molds and mold components in a more cost effective and timely manner and having production-ready surfaces.

### BACKGROUND

The majority of consumer and industrial products are made from at least a few components that are injection molded from plastic. Injection molding is capable of producing parts that are complex, durable, and yet relatively inexpensive. Parts as large as patio tables and chairs, for example, and parts as small as components for watches are injection molded.

The molds typically used in injection molding machines are machined most commonly from steel or aluminum blocks and this is a slow and expensive procedure. The conventional method of making molds or mold cavities and cores is to use computer numerical controlled (CNC) machines to cut the mold or mold component from a solid metal billet or to duplicate off a model on a duplicating machine. These processes leave machine marks that require manual benching or polishing to create the desired surface finish. The molds and methods disclosed herein minimize or eliminate these steps which are time consuming and expensive. In addition, less metal is needed to manufacture the cavity and core. The time from completion of the part design to mold completion is greatly reduced. The end result is a less expensive and faster mold build.

### BRIEF SUMMARY

Disclosed herein are methods of making a mold having a production-ready surface. One disclosed method comprises creating an expanded geometric computer model of a mold. A physical model of the mold is produced based on the expanded geometric computer model using a material that disintegrates at sufficient temperature. A ceramic cast from the physical model is created, and then a molten metal is poured into the ceramic cast, thereby disintegrating the physical model. The molten metal is cooled and the ceramic cast is removed from the cooled metal to reveal the mold having the production-ready surface.

### BRIEF DESCRIPTION OF THE DRAWINGS

The description herein makes reference to the accompanying drawings wherein like reference numerals refer to like parts throughout the several views, and wherein:

FIG. 1A is a flow diagram of a method of making a mold having production-ready surfaces as disclosed herein;

### DETAILED DESCRIPTION

Disclosed herein are embodiments of a method for producing a mold, tool or die that has a production-ready surface that can be used to make a part or component by various processes including but not limited to injection molding, blow molding, compression molding, vacuum molding and the like. Parts or components numbering from tens to millions can be made from a single mold or tool made from an embodiment disclosed herein. As used herein, the term “mold” describes a hollow form for shaping a fluid, metal or plastic substance that can subsequently be used for casting parts and components. A mold can be a single piece for a plurality of pieces such as a cavity and core. The terms “tool” and “die” refer to a mold developed by the embodiments disclosed herein that is subsequently used to manufacture parts and components. The term “production-ready surface” means a surface for which porosity is not an issue and a surface that requires reduced or no further machining, benching, or sanding to prepare the surface for use of the mold in production. The surface is also ready to accept a texture by conventional methods such as acid etching to produce the textured surface desired on the molded product.

Molds have been produced in the past with sand casting. However, the sand casing process does not yield precision surfaces and can result in surfaces having porosity issues and poor surface quality. Molds produced by sand casting have an additional thickness to the casting, requiring that the surface of the mold be machined by computer numerical control (CNC) to achieve the required mold dimensions. Furthermore, after CNC machining, hand benching is required to remove the CNC cutter marks. This is labor intensive, costly and time consuming. Volume production of parts or components can exacerbate problems in molds used to produce plastic components. Friction, especially in softer molds, tends to wear the mold materials quickly. The balance between high cost materials and reworking worn molds play a key role in the cost of production due to the need for new or reworked molds as well as potentially rejected products. Some molds made with composite materials last a long time, but require expensive bits to cut and longer times to create as cutting tools shave away microscopic layers. There is a need for the production of molds with lower costs and labor requirements.

The molds created from the embodiments disclosed herein can be used to produce plastic parts and components and die cast parts and components. The molds are able to match the features and tolerances necessary to create the required geometry for the specified accuracy for manufacturers of the parts and components without the need for further processing by CNC or the like. The molds produced from the methods herein can be made cost effectively for high or low volume production with very little or no surface preparation.

As noted, the molds created from the embodiments herein can be used in injection molding, blow molding, vacuum forming, and compression molding of both thermoplastics and thermosets. However, the use of the created mold is not limited to these molding, forming and casting procedures. Similar procedures known to those skilled in the art can be used with the mold to create a part or component.

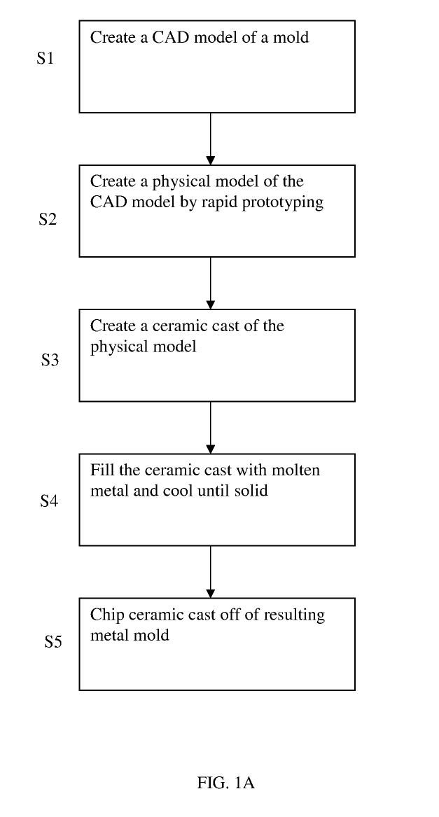

FIG. 1 is a flow diagram of an embodiment of a process as disclosed herein. The first step S1 is to create a computer aided design (CAD) of the mold that is to be produced. As used herein, “CAD” includes CADD, both one to one and expanded geometric computer modeling and animation modeling software. This virtual mold can be two or three dimensional depending on the mold design. The virtual mold is then used to make a physical model of the mold in step S2. The physical model can be made by a rapid prototyping process. As used herein, “rapid prototyping” includes techniques for manufacturing the model by sequential delivery of energy and material to specified points in space to produce the solid model from the three-dimensional virtual model and can also be referred to as solid freeform fabrication, layered manufacturing, additive fabrication and additive manufacturing. Specific non-limiting examples of rapid prototyping include stereolithography, laminated object manufacturing, selective laser sintering, laser engineered net shaping, solid ground curing and others known to those skilled in the art. The creation of the physical model accounts for the expansion that occurs due to metal shrink and the molding material shrink that occur when molds are made by the conventional method.

In step S2, the three-dimensional virtual mold is programmed into a rapid prototyping machine and is transformed into the physical model. For example, using stereolithography, the model of the mold is built layer by layer using a laser beam to solidify the surface in a liquid polymer. The layers typically range in thickness from 0.002″ to 0.006″. The physical model can be made from any material that disintegrates when contacted by molten metal. Typical non-limiting examples of material that can be used are paper, plastic, wax and foam.

It is contemplated that the physical model could also be produced using CNC or even be manually made by hand. The resulting physical model could then be used to create a wax model that could be used in the subsequent step S3. However, both the CNC and manual process adds additional steps that are not necessary if rapid prototyping is used, which increases the length of the process. Using the CNC process adds additional cost. Furthermore, the precision and smooth surfaces cannot be obtained with these processes.

In step S3, a ceramic cast is made of the physical model. The ceramic forming technique used can be any known to those skilled in the art to produce the required ceramic cast. Non-limiting examples include ceramic shell casting and slip casting. The physical model is powder coated in ceramic and heated to harden the ceramic. This process may need to be repeated a plurality of times to produce the desired thickness of the ceramic cast. As a non-limiting example, the ceramic mold can be produced by repeating a three step process. The first step involves dipping the physical model into a slurry of fine refractory material and then letting any excess drain off, so a uniform surface is produced. This fine material is used in the first dip to give a smooth surface finish and reproduce fine details. In the second step, the cluster can be stuccoes with a coarse ceramic particle, by dipping it into a fluidized bed, placing it in a rain sander, or by applying the powder by hand. Finally, the coating is allowed to harden or is baked. These steps are repeated until the ceramic cast is the required thickness, which will vary depending on the size of the mold. Smaller molds may have a thickness of 5 to 15 mm (0.2 to 0.6 in) for example while larger molds may need to have a much greater thickness. Alternative forms of refractory or ceramic coating, using alternative refractory and alternative binding agents may be employed.

In step S4, a molten metal is poured into the ceramic cast. The molten metal can be aluminum, steel, bronze, copper or alloys as non-limiting examples. The physical model over which the ceramic cast was created is disintegrated upon contact with the molten metal. The ceramic cast with the molten metal is cooled until the metal is solid.

Once the metal has solidified, the ceramic cast is chipped or broken off of the metal mold in step S5. The resulting metal mold can now be used as a production mold with minimal machining or benching. The ceramic cast yields a precision mold with little or no porosity and a production-ready surface with no further processing required. The molds produced with the embodiments herein can be used to produce final products with smooth finishes.

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of making a mold having a production-ready surface comprising:
creating a geometric computer model of a mold;
producing a physical model of the mold based on the expanded geometric computer model using a material that disintegrates at sufficient temperature;
creating a ceramic cast from the physical model;
pouring a molten metal into the ceramic cast;
cooling the molten metal; and
removing the ceramic cast from the cooled metal to reveal the mold having the production-ready surface.

2. The method of claim 1, wherein the physical model is produced by rapid prototyping.

3. The method of claim 2, wherein the rapid prototyping is stereolithography.

4. The method of claim 1, wherein the physical model is made from one of foam, plastic, paper and wax.

5. The method of claim 1, wherein the molten metal is one or aluminum, steel, bronze, copper and an alloy.

6. The method of claim 1, wherein creating the ceramic cast comprises:
dipping the physical model in a ceramic powder;
baking the physical model with the ceramic powder; and
repeating one or both of dipping and baking as required.
